(19) United States
(12) Patent Application Publication
(10) Pub. No.: US 2017/0361664 A1
(43) Pub. Date: Dec. 21, 2017

(54) METALLIC BEAD STRUCTURE

(71) Applicants: Bridgestone Americas Tire Operations, LLC, Nashville, TN (US); Firestone Industrial Products Company, LLC, Indianapolis, IN (US)

(72) Inventors: David J. Zemla, Canal Fulton, OH (US); Jon I. Stuckey, Uniontown, OH (US); Joshua R. Leonard, Noblesville, IN (US)

(21) Appl. No.: 15/540,111

(22) PCT Filed: Dec. 2, 2015
(86) PCT No.: PCT/US2015/063467

§ 371 Date: Jun. 27, 2017

Related U.S. Application Data
(60) Provisional application No. 62/098,351, filed on Dec. 31, 2014.

(51) Int. Cl. B60C 15/06; B60C 15/05

(52) U.S. Cl. CPC B60C 15/0603; B60C 15/05

(57) ABSTRACT

A rubber article having a metallic tubular bead structure is provided. The bead structure may include a substantially hollow cavity. In one embodiment, a bead structure for use in a vehicle tire is provided, the bead structure comprising: a wall defining a cavity, wherein the wall includes at least one of a substantially teardrop-shaped cross-section and a substantially triangular cross section; and a bead filler portion; wherein the bead structure is formed into an annulus.

### BACKGROUND

In the manufacture of a rubber article, including for example a vehicle tire, a bead structure may be integrated into the article to create a stiffened portion of the article for interface with another element, including for example a vehicle wheel. Additionally, a bead structure may act to anchor reinforcing elements, including for example one or more body plies.

A bead structure may traditionally include a bead bundle, including for example one or more metal bead wires oriented adjacent one another. A bead structure may traditionally include a rubber bead filler, configured to fill a void created adjacent the bead bundle following turnup of one or more body plies about the bead bundle. Traditionally, the bead bundle and bead filler are separate components that must be assembled together during the manufacture of the rubber article.

Traditionally, the bead filler and bead bundle are solid elements. As a result, these elements may be heavier than a similarly-shaped hollow element Likewise, these solid bead filler and/or bead bundle elements may not permit introduction or translation of other materials within the interior of the bead filler and/or bead bundle elements.

What is needed is a metallic bead structure that may be at least partially hollow to allow for introduction of other materials therein and/or which is lighter than traditional bead elements.

### SUMMARY

In one embodiment, a bead structure for use in a vehicle tire is provided, the bead structure comprising: a wall defining a cavity, wherein the wall includes at least one of a substantially teardrop-shaped cross-section and a substantially triangular cross section; and a bead filler portion; wherein the bead structure is formed into an annulus.

In another embodiment, a bead structure for use in a vehicle tire is provided, the bead structure comprising: a wall defining a cavity, wherein the wall includes at least one of a substantially teardrop-shaped cross-section and a substantially triangular cross section; and a bead filler portion; and a bead bundle portion.

In another embodiment, a bead structure for use in a vehicle tire is provided, the bead structure comprising: a wall defining a cavity, wherein the wall includes at least one of a substantially teardrop-shaped cross-section and a substantially triangular cross section; and a bead filler portion; and a bead wire bundle.

### BRIEF DESCRIPTION OF THE DRAWINGS

The accompanying figures, which are incorporated in and constitute a part of the specification, illustrate various example systems and apparatuses, and are used merely to illustrate various example embodiments. In the figures, like elements bear like reference numerals.

FIG. 1A illustrates a sectional view of an example embodiment of a bead structure 100.

FIG. 1B illustrates a sectional view of an example embodiment of bead structure 100 including balancing elements 110.

FIG. 2 illustrates a sectional view of an example embodiment of a tire 220 including a bead structure 200.

FIG. 3A illustrates a sectional view of an example embodiment of a bead structure 300.

FIG. 3B illustrates a sectional view of an example embodiment of bead structure 300 including balancing elements 310.

FIG. 4 illustrates a sectional view of an example embodiment of a tire 420 including a bead structure 400.

FIG. 5A illustrates a sectional view of an example embodiment of a bead structure 500 including an over-molded bead filler 506.

FIG. 5B illustrates a sectional view of an example embodiment of bead structure 500 including an over-molded bead filler 506 and balancing elements 510.

FIG. 6A illustrates a sectional view of an example embodiment of an over-molded bead structure 600.

FIG. 6B illustrates a sectional view of an example embodiment of over-molded bead structure 600 including balancing elements 610.

FIG. 7A illustrates a sectional view of an example embodiment of a bead structure 700 including a cut-out 718.

FIG. 7B illustrates a sectional view of an example embodiment of bead structure 700 including a cut-out 718, at least partially engaged by body plies 728A and 728B.

FIG. 7C illustrates a sectional view of an example embodiment of bead structure 700 including a cut-out 718, at least partially engaged by body plies 728A and 728B, and including balancing elements 710.

FIG. 8A illustrates a sectional view of an example embodiment of a bead structure 800 including a cut-out 818.

FIG. 8B illustrates a sectional view of an example embodiment of bead structure 800 including a cut-out 818, at least partially engaged by body plies 828A and 828B.

FIG. 8C illustrates a sectional view of an example embodiment of bead structure 800 including a cut-out 818, at least partially engaged by body plies 828A and 828B, and including balancing elements 810.

### DETAILED DESCRIPTION

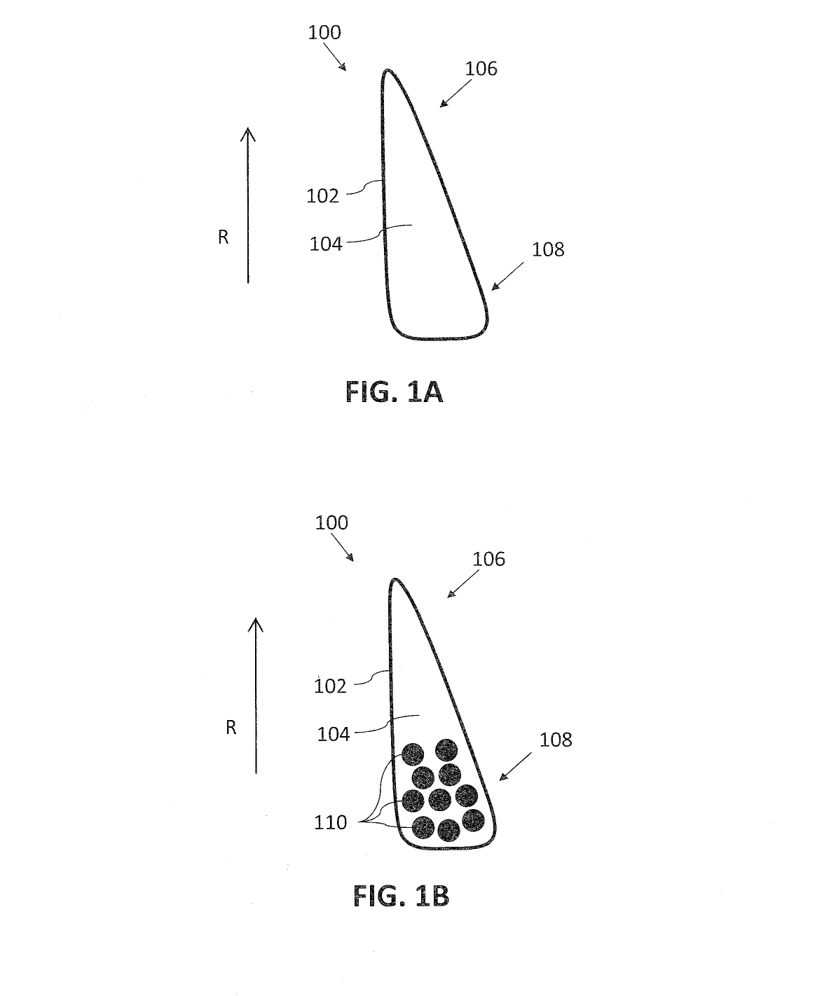

FIG. 1A illustrates a sectional view of an example embodiment of a bead structure 100. Bead structure 100 may include a wall 102. Wall 102 may define a cavity 104. Bead structure 100 may include a bead filler portion 106. Bead structure 100 may include a bead bundle portion 108.

Bead structure 100 may be a bead structure for molding within a rubber article (not shown). Bead structure 100 may be a bead structure for molding within a vehicle tire (not shown). Bead structure 100 may be a bead structure for molding within a pneumatic vehicle tire. Bead structure 100 may be a bead structure for molding within a non-pneumatic vehicle tire. Bead structure 100 may provide structural integrity to an interface between a vehicle tire and a vehicle wheel. Bead structure 100 may provide an anchor point for reinforcement within a vehicle tire, including such reinforcement as one or more body ply.

Bead structure 100 may be substantially annular in shape. Bead structure 100 may be oriented within a vehicle tire and may extend along the circumference of the vehicle tire. A vehicle tire may include a plurality of bead structures 100. A vehicle tire may include at least two bead structures 100. A vehicle tire may include two bead structures 100-a first bead structure 100 oriented on an inboard side of the tire, and a second bead structure 100 oriented on an outboard side of the tire.

Wall 102 may be a relatively thin sheet of material, relative to the width (axially) and/or height (radially, as designated by R) of bead structure 100. Wall 102 may have a thickness/gauge of between about 0.5 mm and about 10.0 mm. Wall 102 may have a thickness/gauge of between about 0.7 mm and about 6.0 mm. Wall 102 may have a thickness/gauge of about 1.0 mm. Wall 102 may have a thickness/gauge of about 2.0 mm. Wall 102 may have a thickness/gauge of about 3.0 mm. Wall 102 may have a thickness/gauge of about 4.0 mm. Wall 102 may have a substantially constant thickness. Wall 102 may have a varied thickness, such that certain portions of wall 102 are selectively thicker or thinner than other portions.

Wall 102 may include any of a variety of materials, including for example a metal, an alloy, a polymer, a composite, and the like. Wall 102 may include a metal such as steel. Wall 102 may include a metal such as stainless steel. Wall 102 may include an alloy such as aluminum. Wall 102 may include an alloy such as titanium. Wall 102 may comprise a metallic structure.

Wall 102 may be formed into a substantially teardrop-shaped cross-section. Wall 102 may be formed into a substantially triangular cross-section. Wall 102 may be formed into at least one of a substantially teardrop-shaped cross-section and a substantially triangular cross-section. Wall 102 may be formed with any of a variety of cross-sections, including for example a rectangular cross-section, a square cross-section, an oval-shaped cross-section, a circular cross-section, and the like. Wall 102 may be formed using roll forming processes. Wall 102 may have a cross-section similar to that of a traditional wire bead bundle and traditional bead filler following curing of the same within a vehicle tire.

Wall 102 may be a strip of flat sheet metal roll formed into a tube. Wall 102 may be a strip of flat sheet metal roll formed into a tube, and then formed into a hoop. The hoop may include any diameter as required to meet tire specifications. The hoop may include two distinct ends. The ends may be attached to one another so as to form a continuous hoop or ring of material. The ends may be attached to one another through any of a variety of mechanisms, including for example welding, an adhesive, an epoxy, a fastener, and the like.

Wall 102 may be formed from a section of billet material. Wall 102 may be formed about a mandrel. Wall 102 may be formed through any of a variety of methods to prepare a tube and/or ring-shaped tube.

Cavity 104 may be a substantially hollow cavity defined by wall 102. Cavity 104 may contain only air, by virtue of exposure to air during manufacturing. Cavity 104 may be at least partially filled with a material. Cavity 104 may be at least partially filled with a material configured to adjust the strength of bead structure 100. Cavity 104 may be completely filled with a material configured to adjust the strength of bead structure 100. Cavity 104 may be at least partially filled with a material configured to adjust the properties of bead structure 100. Cavity 104 may be completely filled with a material configured to adjust the properties of bead structure 100.

Cavity 104 may be at least partially filled with any of a variety of materials, including for example: a foam, a rubber, a polymer, a metal, a liquid, a pressurized gas, and the like. The material may include a foam, for example a closed cell foam, an open cell foam, a foam rubber, and the like. The material may include a polymer, for example a solid polymer, a polymer having a webbing structure, a ground polymer, a flake polymer, and the like. The material may include a metal, for example a solid metal, a metal having a webbing structure, a ground metal, a flake metal, and the like. The material may include a liquid, for example a liquid having a high density such as mercury, a liquid having a density similar to water, an oil, and the like.

Cavity 104 may be at least partially filled with elements configured to adjust the balance of a vehicle tire incorporating bead structure 100. For example, cavity 104 may be at least partially filled with one or more dynamic balancing elements (not shown). The dynamic balancing elements may comprise spheres configured to travel within a ring-shaped bead structure 100 and maintain position via centrifugal force where it is necessary to improve dynamic properties of a tire. The dynamic balancing elements may include a liquid configured to travel within a ring-shaped bead structure 100. The dynamic balancing elements may include a powdered material configured to travel within a ring-shaped bead structure 100.

Bead structure 100 may include a single cavity 104 extending about the circumference of bead structure 100. Alternatively, bead structure 100 may include a plurality of cavities 104 extending in parallel about the circumference of bead structure 100. Alternatively, bead structure 100 may include a plurality of chambers within cavity 104 as it extends about the circumference of bead structure 100, such that cavity 104 is broken by dividers into a series of cavities 104 that extend around the circumference of bead structure 100. Alternatively, bead structure 100 may include any combination of the cavity arrangements disclosed above.

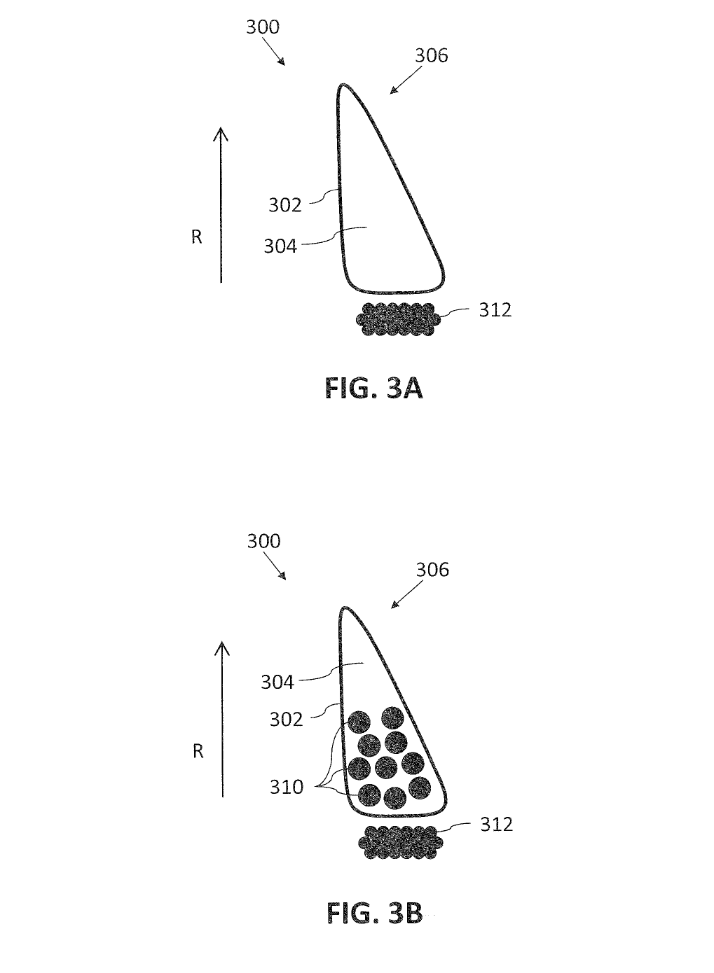

Bead structure 100 may include bead filler portion 106 and bead bundle portion 108. Thus, bead structure 100 may replace a traditional two-piece bead filler and bead bundle assembly. Alternatively, bead structure 100 may include a substantially hollow bead filler portion 106 while including a traditional bead bundle of any variety (see FIGS. 3A-3B). Alternatively, bead structure 100 may include a traditional bead filler portion (not shown) while including a substantially hollow bead bundle.

Wall 102 may include an exterior surface comprising a texture to improve bonding between a rubber of a tire and bead structure 100. Wall 102 may include an exterior surface comprising an adhesive to improve bonding between a rubber of a tire and bead structure 100. Wall 102 may include an exterior surface comprising a coating to improve bonding between a rubber of a tire and bead structure 100.

Wall 102 may include an exterior surface comprising a texture to improve bonding between a body ply of a tire and bead structure 100. Wall 102 may include an exterior surface comprising a ribbed texture to improve bonding between a body ply of a tire and bead structure 100. Wall 102 may include an exterior surface comprising a knurled texture to improve bonding between a body ply of a tire and bead structure 100. Wall 102 may include an exterior surface comprising an adhesive to improve bonding between a body ply of a tire and bead structure 100. Wall 102 may include an exterior surface comprising a coating to improve bonding between a body ply of a tire and bead structure 100.

FIG. 1B illustrates a sectional view of an example embodiment of bead structure 100 including balancing elements 110. As discussed above, balancing elements 110 may include any of a variety of materials, material types, material sizes, material shapes, and the like. Balancing elements 110 may comprise a plurality of spherical elements configured to travel about the circumference of a ring-shaped bead structure 100.

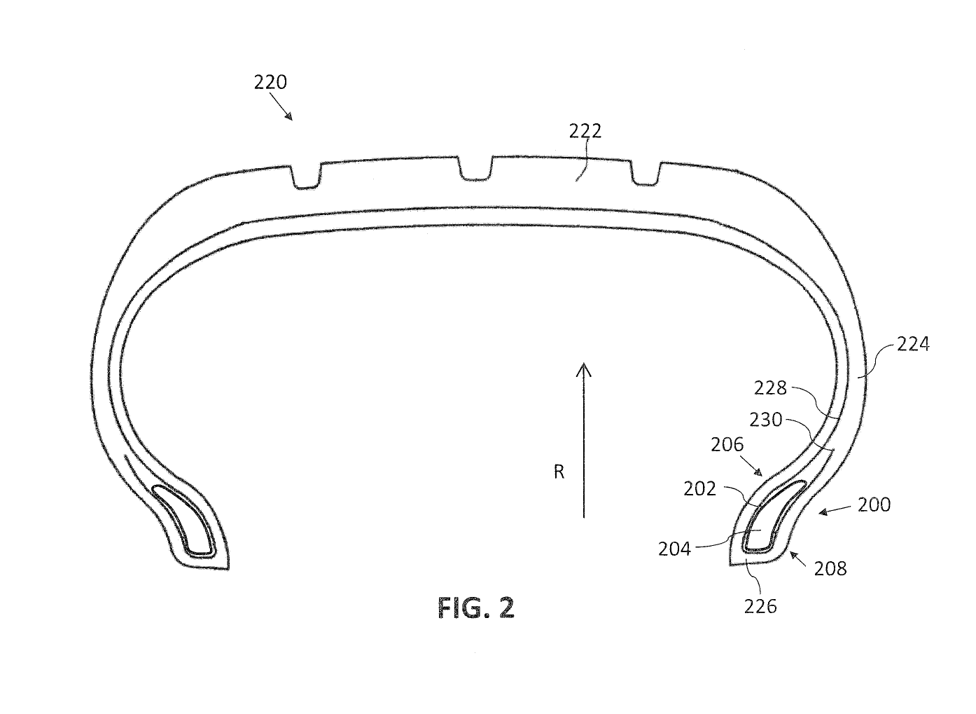

FIG. 2 illustrates a sectional view of an example embodiment of a tire 220 including a bead structure 200.

Bead structure 200 may include a wall 202. Wall 202 may define a cavity 204. Bead structure 200 may include a bead filler portion 206. Bead structure 200 may include a bead bundle portion 208.

Tire 220 may include a tread portion 222. Tire 220 may include at least one sidewall 224. Tire 220 may include at least one bead portion 226. Bead structure 200 may be oriented in at least one bead portion 226.

Tire 220 may include at least one reinforcement element. The at least one reinforcement element may be at least one body ply 228. Tire 220 may include a plurality of body plies 228. Body ply 228 may extend about at least a portion of bead structure 200. Body ply 228 may include a turnup end 230 representing that portion at which body ply 228 terminates after extending about at least a portion of bead structure 200. Turnup end 230 may be oriented radially outwardly of bead structure 200. Turnup end 230 may be oriented radially inwardly of at least a portion of bead structure 200.

Bead filler potion 206 may act to at least partially fill the void created radially outward of bead bundle portion 208, between turnup end 230 and the remainder of body ply 228.

Tire 220 may be substantially annular in shape, and bead structure 200 may extend along the circumference of tire 220.

FIG. 3A illustrates a sectional view of an example embodiment of a bead structure 300. Bead structure 300 may include a wall 302. Wall 302 may define a cavity 304. Bead structure 300 may include a bead filler portion 306. Bead structure 300 may include a bead wire bundle 312.

Bead structure 300 may be substantially similar to bead structure 100 described above with respect to FIGS. 1A-1B.

Wall 302 may define cavity 304, which may define bead filler portion 306. Bead filler portion 306 may be oriented radially outward of bead wire bundle 312. Bead filler portion 306 may be oriented adjacent to bead wire bundle 312. Bead wire bundle 312 may include a plurality of bead wires oriented adjacent one another. Bead wire bundle 312 may include a traditional bead wire bundle. Bead wire bundle 312 may alternatively include any traditional bead reinforcement used in a vehicle tire.

Use of bead wire bundle 312 in combination with bead filler portion 306 may permit flexion in a tire to permit easier mounting of the tire upon a vehicle wheel. This combination may include any of the benefits described above pertaining to weight savings, utilization of cavity 304, strength modification, property modification, and the like.

Bead filler portion 306 may be connected to bead wire bundle 312. Bead filler portion 306 may be operatively connected to bead wire bundle 312. Bead filler portion 306 may be adhered to bead wire bundle 312. Bead filler portion 306 may be bonded to bead wire bundle 312. Bead wire bundle 312 may be coated with a material, which is configured to bond with and/or crosslink with a material coating bead filler portion 306. Bead filler portion 306 may include a concave portion configured to at least partially accept and/or nest with at least a portion of bead wire bundle 312.

FIG. 3B illustrates a sectional view of an example embodiment of bead structure 300 including balancing elements 310. Balancing elements 310 may be substantially similar to balancing elements 110 described above with respect to FIGS. 1A-1B.

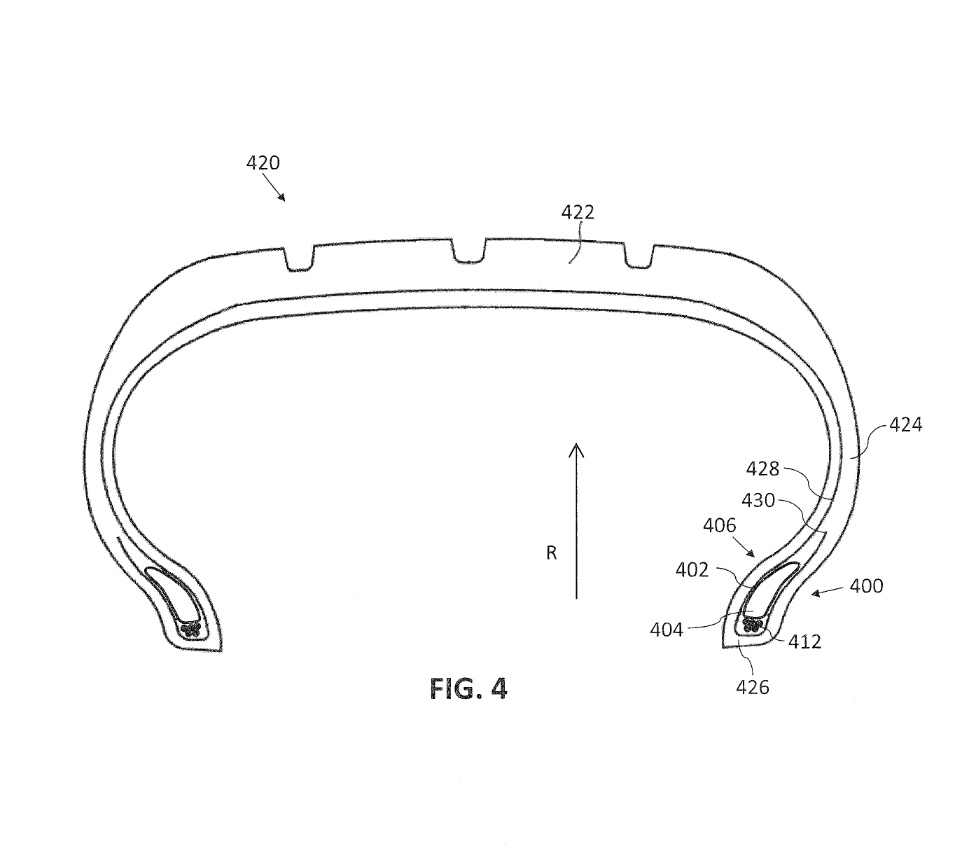

FIG. 4 illustrates a sectional view of an example embodiment of a tire 420 including a bead structure 400.

Bead structure 400 may include a wall 402. Wall 402 may define a cavity 404. Bead structure 400 may include a bead filler portion 406. Bead structure 400 may include a bead wire bundle 412.

Tire 420 may include a tread portion 422. Tire 420 may include at least one sidewall 424. Tire 420 may include at least one bead portion 426. Bead structure 400 may be oriented in at least one bead portion 426.

Tire 420 may include at least one reinforcement element. The at least one reinforcement element may be at least one body ply 428. Tire 420 may include a plurality of body plies 428. Body ply 428 may extend about at least a portion of bead structure 400. Body ply 428 may include a turnup end 430 representing that portion at which body ply 428 terminates after extending about at least a portion of bead structure 400.

Tire 420 and the orientation of bead structure 400 therein may be substantially similar to tire 220 and bead structure 200 described above with respect to FIG. 2.

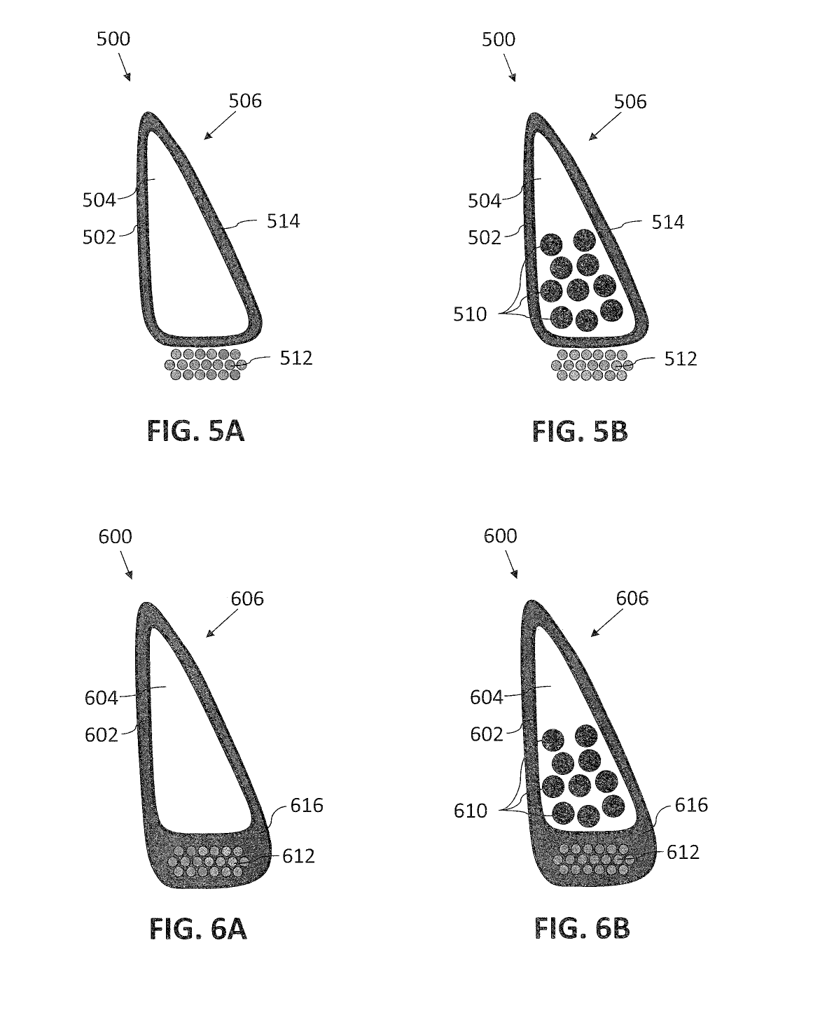

FIG. 5A illustrates a sectional view of an example embodiment of a bead structure 500. Bead structure 500 may include a wall 502. Wall 502 may define a cavity 504. Bead structure 500 may include a bead filler portion 506. Bead structure 500 may include a bead wire bundle 512.

Bead structure 500 may be substantially similar to bead structure 300 described above with respect to FIGS. 3A-3B.

Bead filler portion 506 may include a bead filler over-mold 514. Bead filler over-mold 514 may comprise a layer of material at least partially surrounding bead filler portion 506. At least a portion of bead filler portion 506 may be at least partially surrounded by bead filler over-mold 514. Bead filler over-mold 514 may comprise a layer of material completely surrounding bead filler portion 506. Bead filler over-mold 514 may comprise a layer of any of a variety of materials, including for example a polymer, a rubber, a coating, an adhesive, and the like. Bead filler over-mold 514 may be configured to aid in bonding between bead filler portion 506 and a rubber of the tire. Bead filler over-mold 514 may be configured to aid in bonding between bead filler portion 506 and a body ply. Bead filler over-mold 514 may be configured to aid in bonding between bead filler portion 506 and bead wire bundle 512.

FIG. 5B illustrates a sectional view of an example embodiment of bead structure 500 including balancing elements 510. Balancing elements 510 may be substantially similar to balancing elements 110 described above with respect to FIGS. 1A-1B.

FIG. 6A illustrates a sectional view of an example embodiment of a bead structure 600. Bead structure 600 may include a wall 602. Wall 602 may define a cavity 604. Bead structure 600 may include a bead filler portion 606. Bead structure 600 may include a bead wire bundle 612.

Bead structure 600 may be substantially similar to bead structure 300 described above with respect to FIGS. 3A-3B.

Bead structure 600 may include a bead structure over-mold 616. Bead structure over-mold 616 may comprise a layer of material at least partially surrounding bead structure 600. At least a portion of bead structure 600 may be at least partially surrounded by bead structure over-mold 616. Bead structure over-mold 616 may comprise a layer of material completely surrounding bead structure 600. Bead structure over-mold 616 may comprise a layer of any of a variety of materials, including for example a polymer, a rubber, a coating, an adhesive, and the like. Bead structure over-mold 616 may be configured to aid in bonding between bead structure 600 and a rubber of the tire. Bead structure over-mold 616 may be configured to aid in bonding between bead structure 600 and a body ply. Bead structure over-mold 616 may be configured to aid in bonding between bead filler portion 606 and bead wire bundle 612.

FIG. 6B illustrates a sectional view of an example embodiment of bead structure 600 including balancing elements 610. Balancing elements 610 may be substantially similar to balancing elements 110 described above with respect to FIGS. 1A-1B.

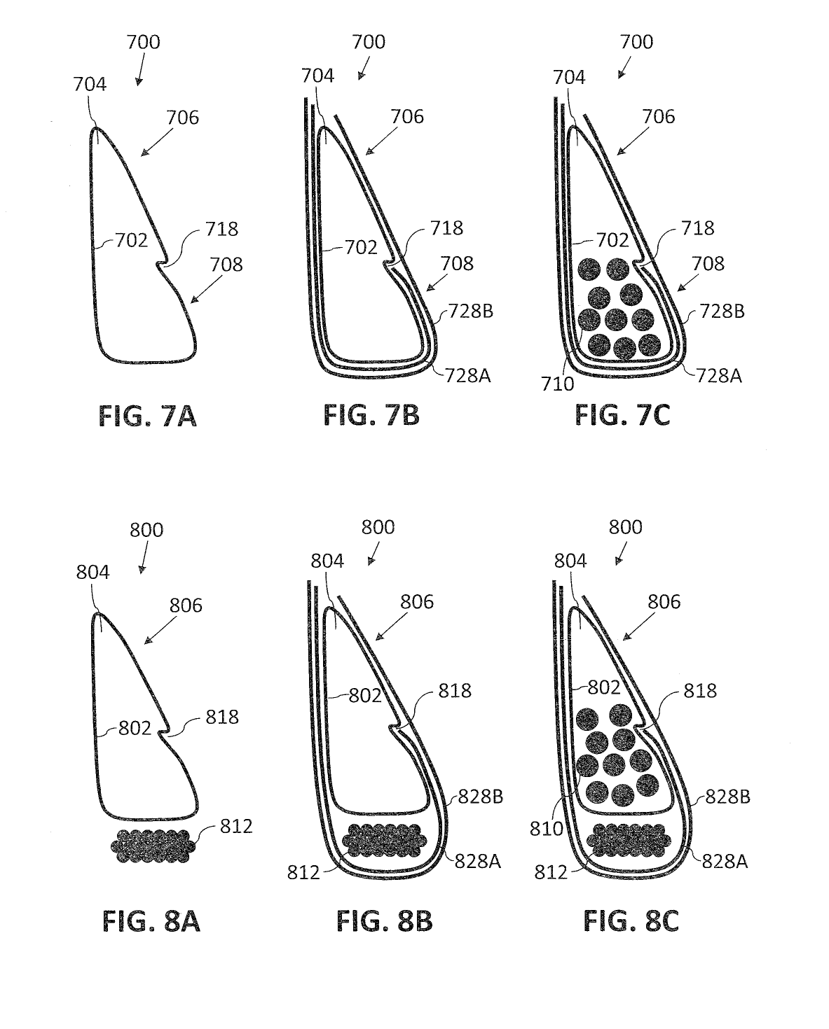

FIG. 7A illustrates a sectional view of an example embodiment of a bead structure 700. Bead structure 700 may include a wall 702. Wall 702 may define a cavity 704. Bead structure 700 may include a bead filler portion 706. Bead structure 700 may include a bead bundle portion 708. Bead structure 700 may include a cut-out 718. Wall 702 may include cut-out 718.

Cut-out 718 may be a notch, groove, indentation, or the like in an axially-outer portion of wall 702. Cut-out 718 may be configured to permit an end of a body ply turnup to be oriented within cut-out 718. Cut-out 718 may accept an end of a first body ply turnup so as to allow a second body ply turnup to be oriented thereover without creating a step at the end of the first body ply turnup. Elimination of this step may at least partially eliminate a stress riser in the second body ply. Cut-out 718 may be circumferential, and may extend about the entire circumference of a ring-shaped bead structure 700.

FIG. 7B illustrates a sectional view of an example embodiment of a bead structure 700 including a first body ply 728A and a second body ply 728B.

First body ply 728A may extend at least partially about bead structure 700. A turnup end of first body ply 728A may be oriented at least partially within cut-out 718.

A turnup end of second body ply 728B may extend at least partially about bead structure 700. A turnup end of second body ply 728B may extend radially past cut-out 718 and the turnup end of first body ply 728A.

FIG. 7C illustrates a sectional view of bead structure 700 including balancing elements 710.

FIG. 8A illustrates a sectional view of an example embodiment of a bead structure 800. Bead structure 800 may include a wall 802. Wall 802 may define a cavity 804. Bead structure 800 may include a bead filler portion 806. Bead structure 800 may include a bead wire bundle 812. Bead structure 800 may include a cut-out 818. Wall 802 may include cut-out 818.

FIG. 8B illustrates bead structure 800 including a first body ply 828A and a second body ply 828B.

First body ply 828A may extend at least partially about bead structure 800. A turnup end of first body ply 828A may be oriented at least partially within cut-out 818.

A turnup end of second body ply 828B may extend at least partially about bead structure 800. A turnup end of second body ply 828B may extend radially past cut-out 818 and the turnup end of first body ply 828A.

FIG. 8C illustrates a sectional view of bead structure 800 including balancing elements 810.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A bead structure for use in a vehicle tire, comprising:
a wall defining a cavity, wherein the wall includes at least one of a substantially teardrop-shaped cross-section and a substantially triangular cross section; and
a bead filler portion;
wherein the bead structure is formed into an annulus.

2. The bead structure of claim 1, further comprising a bead bundle portion.

3. The bead structure of claim 1, further comprising a bead wire bundle.

4. The bead structure of claim 1, wherein an exterior surface of the wall comprises a texture.

5. The bead structure of claim 1, wherein at least one dynamic balancing element is contained within the cavity.

6. The bead structure of claim 3, wherein at least a portion of the bead filler portion is at least partially surrounded by a bead filler over-mold.

7. The bead structure of claim 3, wherein at least a portion of the bead structure is at least partially surrounded by a bead structure over-mold.

8. The bead structure of claim 1, wherein the wall includes a cut-out being at least one of a notch, a groove, and an indentation.

9. A bead structure for use in a vehicle tire, comprising:
a wall defining a cavity, wherein the wall includes at least one of a substantially teardrop-shaped cross-section and a substantially triangular cross section; and
a bead filler portion; and
a bead bundle portion.

10. The bead structure of claim 9, wherein an exterior surface of the wall comprises a texture.

11. The bead structure of claim 9, wherein at least one dynamic balancing element is contained within the cavity.

12. The bead structure of claim 9, wherein the wall includes a cut-out being at least one of a notch, a groove, and an indentation.

13. The bead structure of claim 9, wherein the wall includes at least one of a metal, an alloy, and a polymer.

14. A bead structure for use in a vehicle tire, comprising:
a wall defining a cavity, wherein the wall includes at least one of a substantially teardrop-shaped cross-section and a substantially triangular cross section; and
a bead filler portion; and
a bead wire bundle.

15. The bead structure of claim 14, wherein an exterior surface of the wall comprises a texture.

16. The bead structure of claim 14, wherein at least one dynamic balancing element is contained within the cavity.

17. The bead structure of claim 14, wherein at least a portion of the bead filler portion is at least partially surrounded by a bead filler over-mold.

18. The bead structure of claim 14, wherein at least a portion of the bead structure is at least partially surrounded by a bead structure over-mold.

19. The bead structure of claim 14, wherein the wall includes a cut-out being at least one of a notch, a groove, and an indentation.

20. The bead structure of claim 14, wherein the wall includes at least one of a metal, an alloy, and a polymer.
